(19) United States
(12) Patent Application Publication
(10) Pub. No.: US 2010/0218507 A1
(43) Pub. Date: Sep. 2, 2010

(54) Sustainable Carbon Capture and Sequestration System and Methods

(76) Inventor: Adam Cherson, New York, NY (US)

Correspondence Address: Adam Cherson, 10 West 66th Street, Apt. 27k, New York, NY, 10023, US

(21) Appl. No.: 12/760,737

(22) Filed: Apr. 15, 2010

Related U.S. Application Data
(60) Provisional application No. 61/212,880, filed on Apr. 17, 2009.

(51) Int. Cl. F02C 7/22; C01B 31/30; C01D 7/00; C01B 3/02; C09K 3/00; C01B 5/00; C01B 7/01

(52) U.S. Cl. 60/780; 423/439; 423/422; 252/373; 252/182.32; 423/580.1; 423/409; 423/462

(57) ABSTRACT

An apparatus and method for capturing, separating, transforming, and sequestering carbon wherein said apparatus dissociates a carbon containing feedstock material and reacts the resulting gases with a system-produced brine to create four products: 1) a sodium based carbonate or bicarbonate, 2) ammonium chloride, 3) fresh water, and 4) a multi-purpose building material. End product (1) may be sequestered in any of several ways for durable and long term storage. End product (2) may be used for nutrient enrichment. End products (3) and (4) may be distributed to human populations.

### CROSS-REFERENCE TO RELATED APPLICATIONS

Provisional Application No. 61/212,880, filed on Apr. 17, 2009.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention pertains to the field of endeavor commonly known as greenhouse gas reduction and more specifically to the field of endeavor commonly known as carbon dioxide capture and sequestration or more simply as carbon capture and sequestration (CCS). The invention is to designed to decrease greenhouse gas pollution and reduce the environmental impact of greenhouse gas emissions (U.S. Class. 422/900). Subsidiary fields of endeavor include: algae cultivation (U.S. Class 47/1.4, Int. Cl, A01G 33/00), carbonate or bicarbonate synthesis (U.S. Class. 423/419.1, 423/421-423; Int. Cl. C01D 7/18), preparation of ion-exchanging materials (U.S. Class. 252/184; Int. Cl. C01B 31/16), preparation of nitrogenous fertilizers (U.S. Class. 71/60; Int. Cl. C05C 11/00), chemical destruction or disintegration of waste other than by burning (U.S. Class. 129/184.1), and building material production (U.S. Class. 52/596, 404/27-31; Int. Cl. E04C 1/00, E01C 3/00).

It is well known in the art of global greenhouse gas reduction that to avert the potentially harmful accumulation of environmental carbon levels three paths of action should be followed: (a) reduction of newly created carbon; (b) capture and sequestration of newly created carbon at a point of emission; and (c) capture and sequestration of previously released carbon already in the environment. This invention pertains to the second and third of these paths of action by providing a system to capture, separate, transform, and sequester newly or previously released carbon.

Many CCS concepts have been proposed and discussed in the prior art literature. The essential characteristics of these concepts is summarized in Table 1.

TABLE 1
Prior Modes and Strategies for Carbon Capture and Sequestration

| TYPE | EXAMPLE |
|---|---|
| Flue Gas CO₂ Capture (chemical methods) | Rochelle, GT. 2009. Amine Scrubbing for CO₂ |
| | Capture. Science, 325, pp. 1652-1654. New York, |
| | NY. doi: 10.1126/science.1176731 |
| Flue Gas CO₂ Capture (biological | National Renewable Energy Laboratory. 2001. |
| methods) | Microalgae Production from Power Plant Flue |
| | Gas. pp. 15-17. Golden, Colorado. |
| | http://nrel.gov/docs/fy01osti/29417.pdf |
| Coal Gasification w/CO₂ Capture | FutureGen Alliance. 2010. FutureGen |
| | Technology. Washington, DC. |
| | http://www.futuregenalliance.org/technology.stm |
| Atmospheric CO₂ Capture (chemical) | Zeman,. F. 2008. Experimental Results for |
| | Capturing CO₂ from the Atmosphere. AIChE |
| | Journal, 54(5), pp 1396-1399. New York, NY. doi: |
| | 10.1002/aic.11452 |
| Enhanced Oil Recovery Sequestration | Science Magazine (2009) “Carbon |
| | Sequestration”, [Description of 12 Major Projects |
| | Worldwide], 325, pp. 1644-45. New York, NY |
| Geological Sequestration | National Energy Technology Laboratory. 2010. |
| | Carbon Sequestration: Storage. Washington, DC. |
| | http://www.netl.doe.gov/technologies/carbon_seq/ |
| | core_rd/storage.html |
| Mineral Sequestration | Lackner. K. 2002. Carbonate Chemistry for |
| | Sequestering Fossil Carbon. Annual Review of |
| | Energy and Environment, 27, pp 193-232. Palo |
| | Alto, CA. |
| | doi:10.1146/annurev.energy.27.122001.083433 |
| Ocean Sequestration (direct injection) | Caldeira, K, et al. 2001. Predicting and |
| | evaluating the effectiveness of ocean carbon |
| | sequestration by direct injection. First National |
| | Conference on Carbon Sequestration. |
| | Washington, DC. |
| | www.netl.doe.gov/publications/proceedings/01/ |
| | carbon_seq/p48.pdf |
| Ocean Sequestration (deep sea sediments) | House, KZ, et al. 2006 Permanent carbon dioxide |
| | storage in deep-sea sediments. PNAS, 103(33), |
| | Abstract. pp. 12291. Washington, DC. doi: |
| | 10.1073/pnas.0605318103 |
| Biochar Sequestration | Roberts, KG, et al. 2010. Life Cycle Assessment |
| | of Biochar Systems: Estimating the Energetic, |
| | Economic, and Climate Change Potential. |
| | Environmental Science & Technology, 44 (2). |
| | Abstract p. 827. Washington, DC. |
| | doi: 10.1021/es902266r |
| Biomass CCS | Scholz, F, et al. 2008. Permanent Wood |
| | Sequestration: The Solution to the Global Carbon |
| | Dioxide Problem. ChemSusChem, April 8, |
| | Volume 1, Issue 5, Abstract, pp. 381. Weinheim, |
| | Germany. doi: 10.1002/cssc.200800048 |
| Soil CCS | Sundquist, ET, et al. 2009. Rapid assessment of |
| | U.S. forest and soil organic carbon storage and |
| | forest biomass carbon sequestration capacity: |
| | U.S. Geological Survey Open-File Report 2009- |
| | 1283. Abstract. Washington, DC. |
| | http://pubs.usgs.gov/of/2009/1283 |
| Carbonate Weathering CCS (flue gas) | Rau, G. 2008. Altering Seawater Chemistry to |
| | Mitigate CO₂ and Ocean Acidification.. 5^{th} Annual |
| | California Climate Change Conference. |
| | Sacramento, CA. |
| | www.climatechange.ca.gov/events/2008.../2008.../ |
| | Greg_Rau.pdf |
| Carbonate Weathering CCS (atmospheric) | House, KZ, et al. 2007. Electrochemical |
| | Acceleration of Chemical Weathering as an |
| | Energetically Feasible Approach to Mitigating |
| | Anthropogenic Climate Change. Environmental |
| | Science & Technology, 41 (24), Abstract, pp. |
| | 8464. Washington, DC. doi: 10.1021/es0701816 |
| Ocean Nourishment CCS | Jones, ISF, et al. 2003. Long-term ocean carbon |
| | sequestration with macronutrient addition. |
| | Engineering Carbon Sequestration in the Ocean. |
| | Second Annual Conference on Carbon |
| | Sequestration. Washington, DC. |
| | http://www.netl.doe.gov/publications/proceedings/03/ |
| | carbon-seq/PDFs/110.pdf |
| Ocean Fertilization CCS | Blain, S, et al. 2007. Effect of natural iron |
| | fertilization on carbon sequestration in the |
| | Southern Ocean. Nature, 446, Letter. p 1070. |
| | New York, NY.. doi: 10.1038/nature05700 |

The most prevalent of these involve the capture of CO₂ directly from flue gas or via coal gasification, often combined with enhanced oil recovery or bioenergy production. Other options for storage of flue gas captured CO₂ include geological, mineral, or ocean sequestration. A second type of proposal involves processes for the direct chemical capture of CO₂ from the atmosphere followed by any of the above storage strategies. A final strategy seeks to stimulate natural processes and cycles to accelerate carbon sequestration. This category includes reforestation, aforestation, prevention of deforestation, enhanced carbonate formation, and oceanic nourishment or fertilization. These strategies enlist living biomass, seawater, or soil (including biochar) storage strategies. Related to all three major strategies are efforts to improve chemical or biological capture efficiencies via new methods and materials, and to find secure and ample geological storage reservoirs.

While the prior art offers numerous technologies for CCS, it is respectfully submitted that none of those thus far offered provides an immediately executable and sustainable strategy for reducing greenhouse gases on the scale of 1 billion tonnes of carbon equivalents per year. These are the levels of sequestration that will be needed if CCS is to have any impact on global geochemistry and climate (Pacala, S and Socolow, R. 2004. Stabilization Wedges: Solving the Climate Problem for the Next 50 Years with Current Technologies. Science, 305(5686), pp 968-972. New York, N.Y. doi: 10.1126/science. 1100103). The above systems pose varying obstacles to their implementation at a large scale: 1) land use demands and conflicts, 2) net process energy losses and life cycle carbon positivity, 3) geographic fragmentation of capture mechanisms and a corresponding need for massive pipeline and/or transportation system to collect, concentrate, and sequester CO₂, 4) availability of and access to process input materials, 5) availability and/or efficacy of geological formations suitable for sequestration, 6) impermanence of storage, 7) complexity of infrastructure and retrofitting demands, 8) creation of chemical wastes, 9) lack of economic co-benefits, and 10) lack of co-uses as beneficial infrastructure beyond the CCS applications.

The invention described here is substantially novel and unlike any prior art due not only to its chemical engineering design, but also in that it creates a fully integrated and self-contained method of CCS able to overcome the challenges to immediacy, effectiveness and sustainability mentioned in the prior paragraph. The result is a system that minimizes negative environmental impacts; minimizes interference with existing or potential human activities; minimizes infrastructure fragmentation and complexity; requires easily obtainable and plentiful natural resources; is substantially energy self-reliant; sequesters sufficient quantities of carbon, quickly enough, to have a meaningful impact on environmental levels; creates byproducts of economic value to help defray economic costs; and is adaptable to other production or industrial uses such as renewable energy, fresh water, plant fertilizers, animal feeds, industrial chemicals, solid waste processing, and waste to energy creation. The present invention's essential characteristic resides in its innovative combination of treatment steps, integrating the capture, separation, transformation, and sequestration aspects of CCS so as to improve substantially upon the prior art.

While no known patents or applications exist for a method that integrates the capture, separation, transformation, and sequestration of environmental carbon into one continuous process, there have been other CCS patents or applications. In order to distinguish the novelty and non-obviousness of the present invention, these CCS patents and applications are now summarized. Any system that does not provide its own input materials or that does not fully comprise the capture, separation, transformation, and sequestration aspects of CCS is described as a partial method.

In U.S. Pat. No. 5,397,553, Spencer describes a partial method of carbon dioxide clathrate formation, the cooling of the clathrate, and the pumping of the cooled clathrate to a depth of approximately 1000 meters.

In U.S. Pat. No. 5,975,020, Caveny describes a partial system for land based carbon capture using grassy and herbaceous crops. This system makes no provision for separation, transformation or long term sequestration of the carbon.

In U.S. Pat. No. 5,992,089, Jones, et al. describe a partial system involving the delivery of an exogenous source of nitrogen to a specific layer of the ocean to stimulate the growth of phytoplankton so as to increase the photosynthetic activity of those phytoplankton and to enable the phytoplankton to sink into the deep ocean at the end of their life cycle, thereby sequestering carbon.

In U.S. Pat. No. 6,056,919, Markels (1) describes a partial system whereby exogenous fertilizer is introduced into the oceanic photic zone as a means of enhancing phytoplankton growth.

In U.S. Pat. No. 6,190,301, Murray, et al. describe a partial method of sequestration whereby exogenous carbon dioxide is cooled until solid and then allowed to sink to the sea bottom.

In U.S. Pat. No. 6,200,530, Markels (2) describes a partial system whereby an exogenous fertilizer is introduced into the oceanic photic zone in a spiral patter as a means of enhancing phytoplankton growth.

In U.S. Pat. No. 6,440,367, Markels (3) describes a partial system whereby an exogenous, chelated iron fertilizer is introduced into the oceanic photic zone in a spiral pattern as a means of enhancing phytoplankton growth.

In U.S. Pat. No. 6,890,497, Rau et al. (1) describe a partial system where a gas stream containing CO₂ enters a reactor vessel. In the reactor vessel, CO₂ contacts an aqueous solution and becomes hydrated to form carbonic acid, which in turn reacts with the carbonate to form bicarbonate and metal ions. Waste streams exiting the reactor vessel comprise a gas stream now depleted of CO₂, and an aqueous solution of metal ions and bicarbonate.

In U.S. Pat. No. 7,132,090, Dziedic, et al., describe a partial method of capturing carbon dioxide from a flue gas using a gas diffusion membrane. A carbon dioxide rich fluid is then passed through a matrix containing a catalyst specific for carbon dioxide, which accelerates the conversion of the carbon dioxide to carbonic acid. In the final step, a mineral ion is added to the reaction so that a precipitate of carbonate salt is formed.

In U.S. Pat. No. 7,479,167, Markels (4) describes a method for the production of biofuels from the open ocean, with or without the addition of fertilizer, comprising the testing of currents to determine that a biomass remains in a zone suitable for harvesting; harvesting a portion of the biomass; and processing a portion of the harvested biomass to produce useful components of biofuels. This is not a sequestration system.

In U.S. Pat. No. 7,655,069, Wright et al. (3) describe an air/liquid exchanger comprising an open-cell foam supporting a liquid sorbent. The exchanger may be used for removing trace gaseous components from the air.

In U.S. Pat. No. 7,655,193, Rau, et al. (2) describe a partial system where a gas stream containing CO₂ enters a reactor vessel. In the reactor vessel, CO₂ contacts an aqueous solution and becomes hydrated to form carbonic acid, which in turn reacts with the carbonate to form bicarbonate and metal ions. Waste streams exiting the reactor vessel comprise a gas stream now depleted of CO₂, and an aqueous solution of metal ions and bicarbonate.

In U.S. patent application Ser. No. 11/014,788, Cadours describes a partial system for capturing and separating carbon from an end of pipe, flue gas stream by means of distillation.

In U.S. patent application Ser. No. 11/579,713, Lackner (1) describes a partial system for capturing atmospheric carbon using a chemical pathway involving sodium hydroxide, calcium carbonate, and resulting in a carbon dioxide end product.

In U.S. patent application Ser. No. 11/801,619, Li applies the public domain Solvay and Haber processes. The partial system describes a coal combustion based, end of pipe capture method using exogenous sodium chloride and ammonia. The sequestration method described by Li consists of geological storage plus ocean fertilization.

In U.S. patent application Ser. No. 12/188,856, Pearson describes a system for generating electricity and producing ethanol using steam reformation and gas shift using an exogenous, carbonaceous feedstock. This is not a sequestration system.

In WIPO Application No. PCT/AU2007/000872, Jones, et al. (2) describe a partial method for removing carbon dioxide from the atmosphere comprising the step of delivering exogenous urea from a floating vessel to a region of a photic zone of an ocean, whereby the number of phytoplankton is caused to increase in the region upon addition of the urea.

In WIPO Application No. PCT/AU2008/000211, Gomez describes a partial system for capturing carbon from flue gas using an electrolytic cell and resulting in any of various mineral carbonates.

In WIPO Application No. PCT/US2008/060672, Wright, et al. (1) describe a partial process for removing carbon dioxide from a gas stream, comprising placing the gas stream in contact with a resin, wetting the resin with water, collecting water vapor and carbon dioxide from the resin, and separating the carbon dioxide from the water vapor.

In WIPO Application No. PCT/US2009/054795, Lackner, et al. (2) describe a partial system of sorbent based carbon dioxide removal from air or a gas stream.

In WIPO Application No. PCT/US2009/052194, Saunders describes a partial system consisting of a reactor and a process suitable for extracting carbon dioxide from carbon dioxide-containing gas stream where the carbon dioxide is hydrated to bicarbonate and then dehydrated back to carbon dioxide.

In WIPO Application No. PCT/US2009/046306 Wright, et al., describe a partial method for removing carbon dioxide from a gas stream without consuming excess energy, wherein a solid sorbent material is used to capture the carbon dioxide.

### BRIEF SUMMARY OF THE INVENTION

The invention consists of a system and method for removing carbon dioxide from the environment and storing it away for a long period of time. The system consists of four major steps, or segments: capture, separation, transformation, and sequestration. There are numerous possible embodiments for each of these steps. The preferred embodiment, as well as several major alternative embodiments, are described in the detailed description. In each of the embodiments a carbon-containing feedstock is processed into a sequestration product and several co-products. A schematic overview of such a system is shown in the block diagram of FIG. 1, in accordance with the preferred embodiment of the invention. The processing station may be located on land or at sea and the feedstock may be any carbon-containing material. The preferred embodiment comprises an offshore algae farm and adjoining offshore processing station. The algae farm surrounds the processing plant and produces a flow of carbon-containing feedstock for the station. The feedstock is cultivated and harvested and then brought to the processing station where it is thermally separated to form a product gas. A series of chemical transformations of this product gas leads to various intermediary and end products which are then re-used in the process (N₂, CO, CO₂, H₂, NaCl, Syngas, and H₂O), are dispersed and sequestered back into the environment (NaHCO₃, NH₄Cl, vitreous slag), and are transported away from the system for use in human civilization (H2O, NH₄Cl, building materials). In an alternative embodiment, the system may process feedstock materials that have been captured elsewhere and are imported into the system. In another embodiment, the system may be capturing its own feedstock and importing feedstocks, simultaneously.

### BRIEF DESCRIPTION OF THE SEVERAL VIEWS OF THE DRAWING

FIG. 1 presents a black box diagram representing an overview of the invention showing the inputs and outputs of the preferred embodiment.

FIG. 2 presents a black box diagram representing an overview of the invention showing the inputs and outputs of an alternate embodiment.

FIG. 3 presents a detailed block diagram representing the major steps and sub-steps of the process in the preferred embodiment.

FIG. 4 presents an exemplary illustration showing the offshore macro-algae farm lay-out of the preferred embodiment.

FIG. 5 presents an exemplary illustration showing the harvest and dispersion vessel in the preferred embodiment.

FIG. 6 presents an exemplary illustration showing the macro-algae enclosure system in the preferred embodiment.

FIG. 7 (A: left, B: center, C: right) presents an exemplary illustration showing the processing station in a preferred embodiment for vessel dispersion of end products.

FIG. 8 (A: left, B: center, C: right) presents an exemplary illustration showing the processing station in a preferred embodiment for direct dispersion of end products.

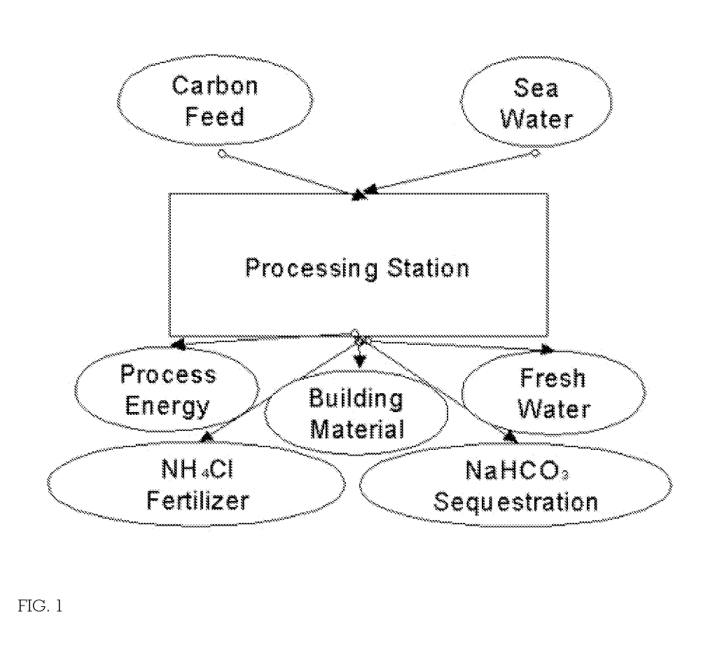

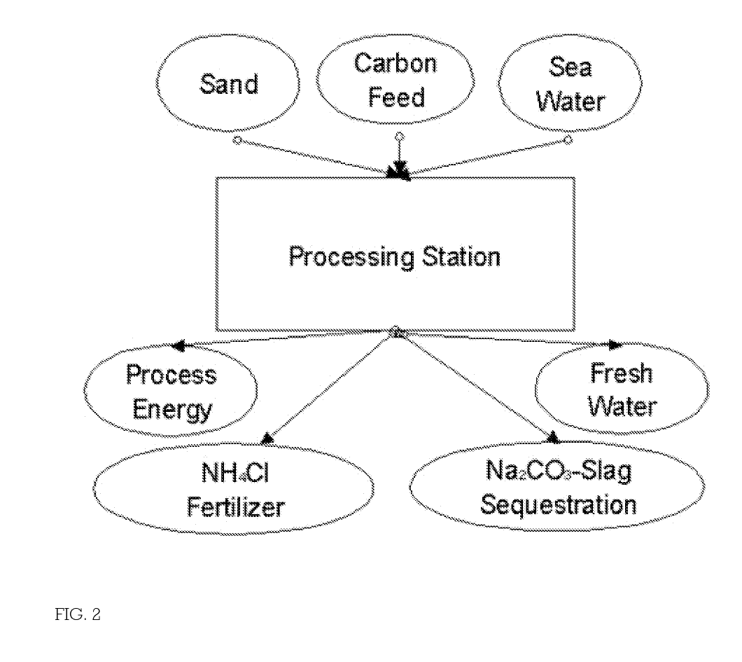

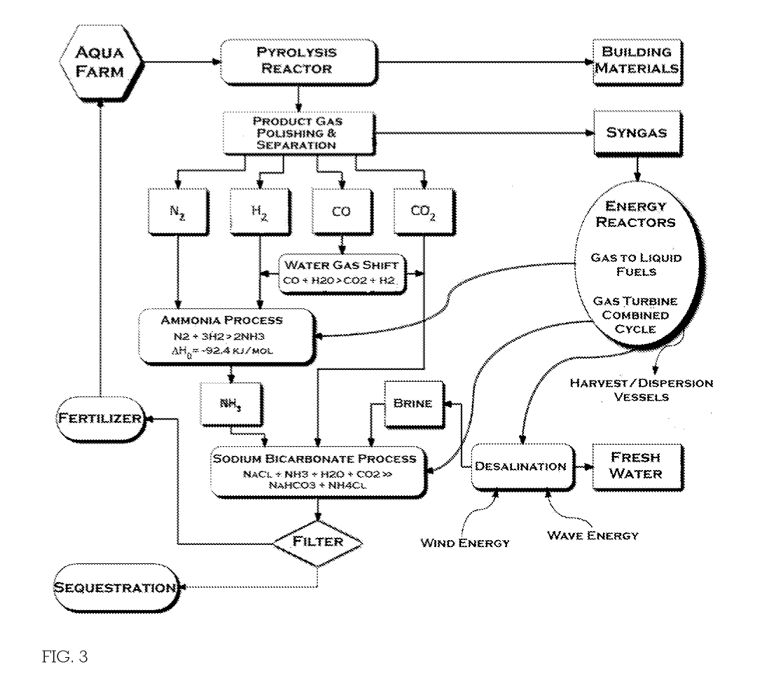

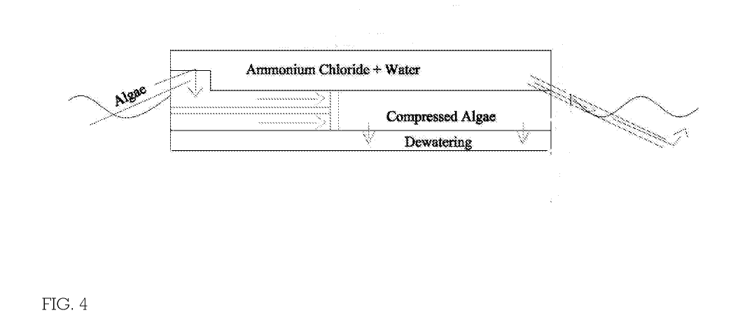

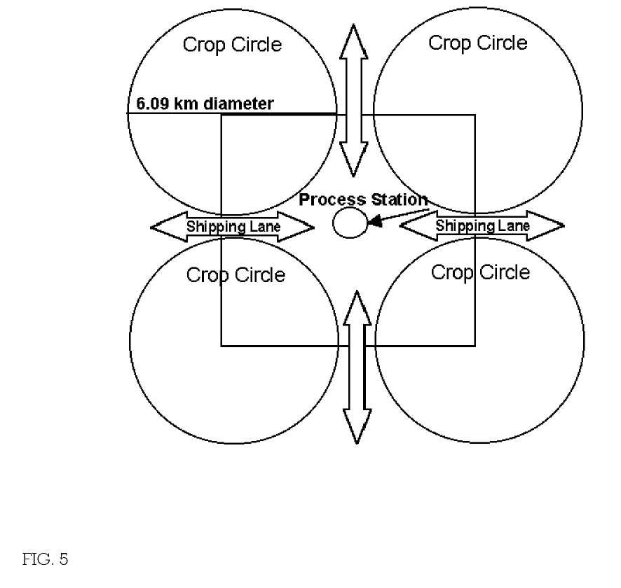

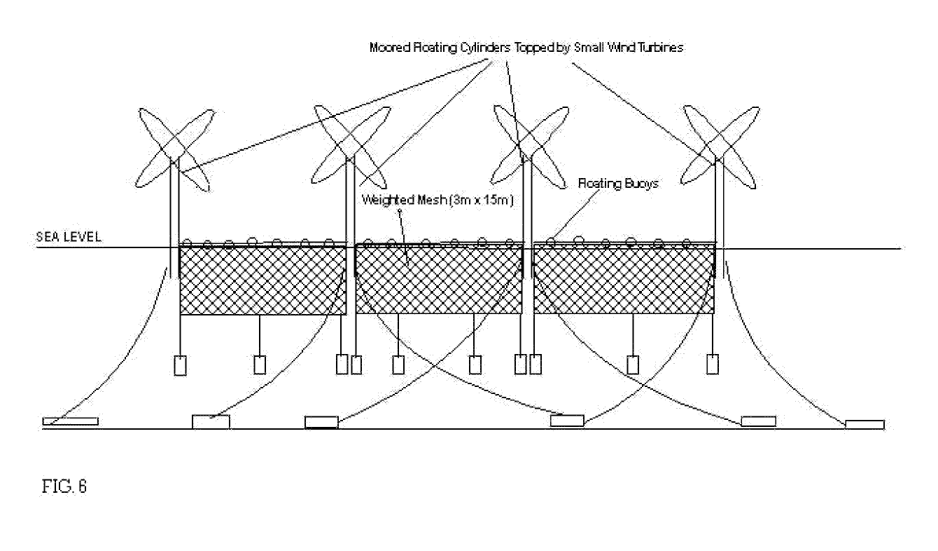

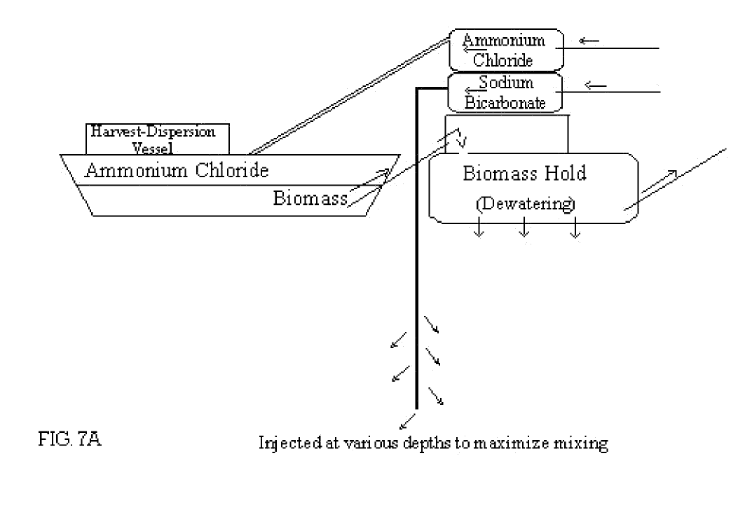

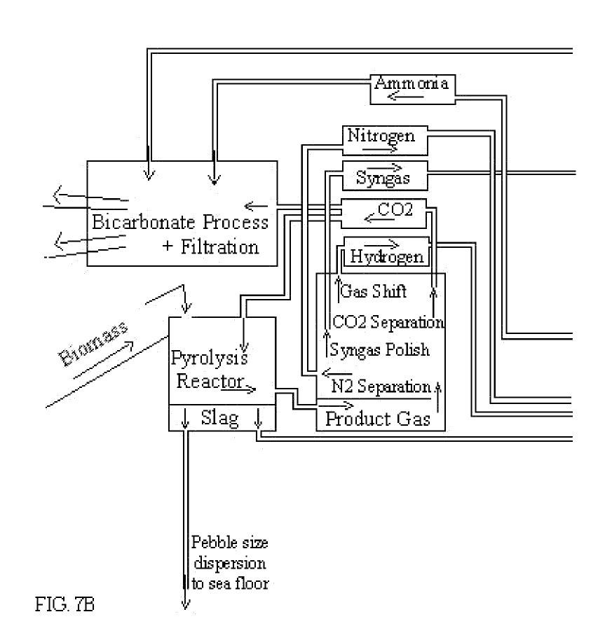

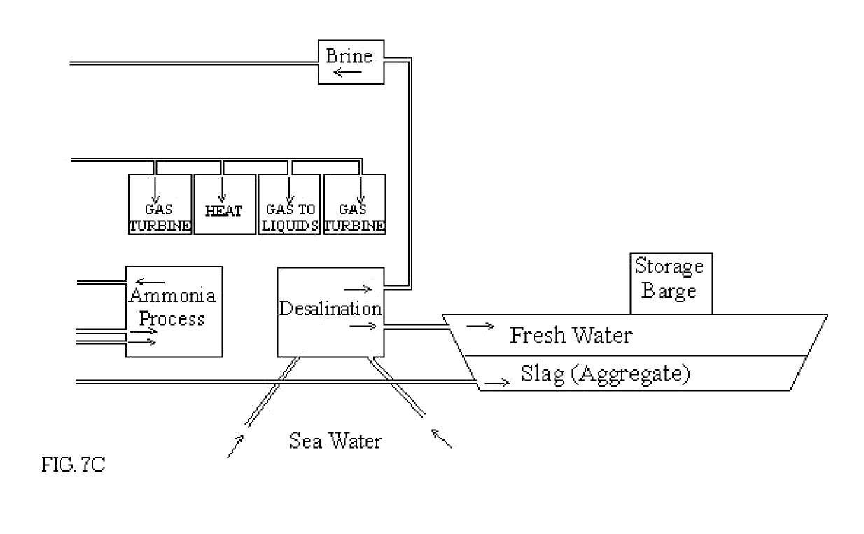

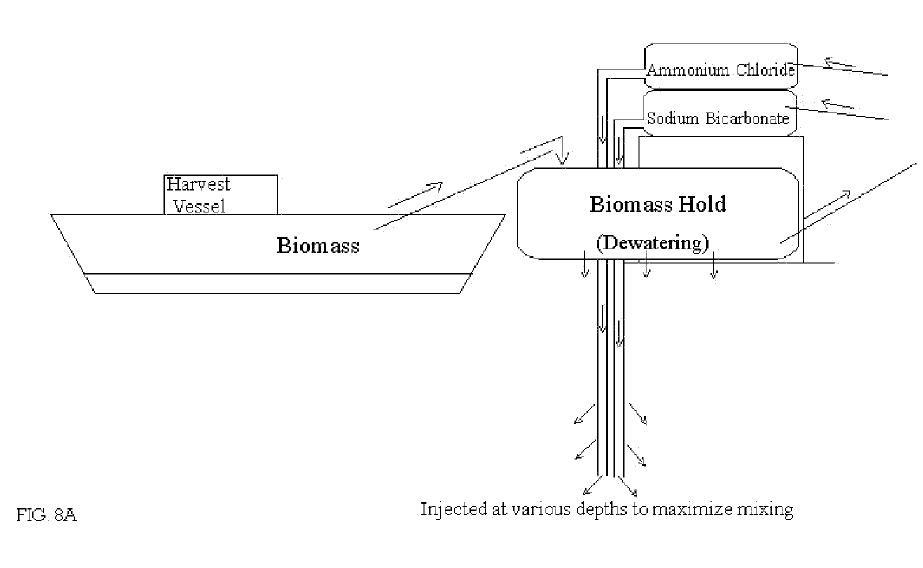

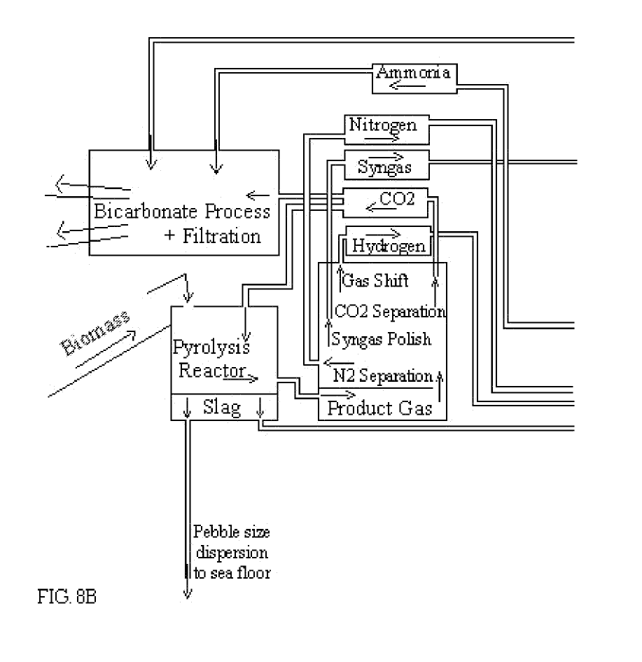

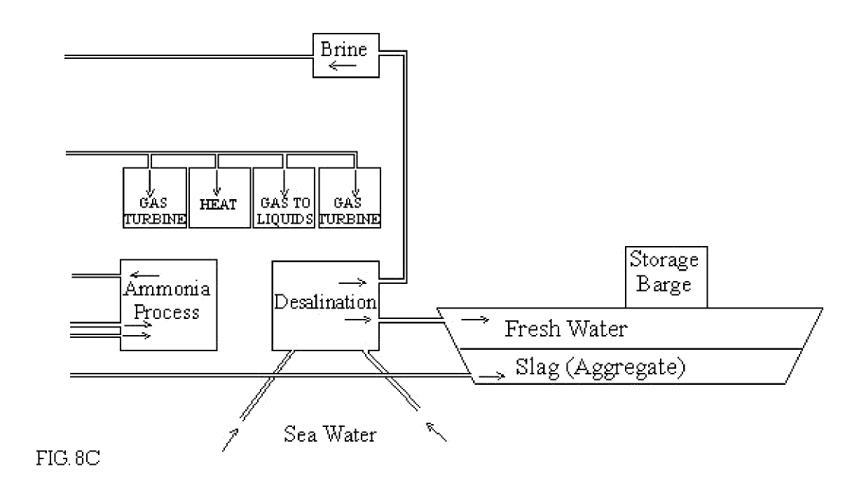

### DETAILED DESCRIPTION OF THE INVENTION

In accordance with the preferred embodiment of the invention, the system comprises a processing platform placed so as to be in relatively close proximity to both the source of input materials going into the system, and the final destination of the processed products produced by the system. The input materials required by the process are a carbon-containing feedstock, saltwater, ambient air, and in certain alternative embodiments, natural sand. The processed products are sodium bicarbonate, ammonium chloride, fresh water, building materials, and, in certain alternative embodiments, a sodium-carbonate-slag sequestration material. The processing platform should be equally distant from the point where the carbon capture will occur, the point where the carbon storage will occur, and the point where the useful co-products will be delivered. In the preferred embodiment, the carbon capture step comprises the cultivation of marine macro-algae and occurs in an area adjacent to the processing plant. In the preferred embodiment, the carbon storage occurs in the unmixed layers of the ocean which begins generally 200 meters below the surface of the ocean and at the edge of the continental shelf. In the preferred embodiment, the useful co-products are be delivered to the closest shipping port. In the preferred embodiment the placement of the processing platform is in an offshore, coastal zone, where saltwater and sand are readily available, where an algae growing area is readily available, and where the processed products may be dispersed or delivered with the least amount of effort to their respective destinations. In embodiments where the carbon-containing feedstock is imported into the system, proximity to the source of this feedstock should also be considered.

The description of this preferred embodiment is not intended to be limiting in any form or manner. Other carbon inputs may be considered as separate embodiments, used as available to replace the algae crop, or to complement the carbon crop. Examples of other carbon inputs include, but are not limited to: other crops including land-based crops, municipal residue biomass, agricultural wastes, sewage sludge, timber milling wastes, refuse derived fuel, paper making wastes, ethanol and other biofuel-making wastes, construction wastes, carbon captured from the environment or from industrial flue gases using alternative biological, chemical, or mechanical means. In each of these cases, the carbon containing material is brought to the processing station and is subjected to the remaining process steps alone or in combination with any other carbon feedstocks.

Capture Step: While any photosynthesizing plant or algae or combination thereof may be considered as a separate embodiment, free-floating marine macro-algae, of one or more species, grown in offshore enclosures are presented here as the preferred embodiment. Reference is made to FIG. 4 which schematically illustrates an exemplary growing-processing area included in the system, in accordance with the preferred embodiment of the invention. The growing-processing area described is not intended to be limiting in any form or manner, and it should be evident to a person skilled in the art that the growing-processing area may be implemented in other ways. Furthermore, the growing-processing area described is ocean-based, although in other embodiments of the invention the growing-processing area may be land-based (and may optionally include inland water bodies), or combined land-ocean-based (partially on land and partially on water). In other embodiments, algae of any type and growth habit may be grown in unenclosed, open ocean areas, in other types of ocean enclosures, inland water bodies, combined land-ocean based systems, land-based agricultural fields, or land-based enclosures. Each of these alternative embodiments will require adaptations that will be evident to a person skilled in the art.

Each growing-processing area includes one or more crop circles wherein the algae is grown, surrounded, for example, by a moored, floating skirt to prevent the algal growth from separating and drifting as shown in Figures X and Y. The growing-processing area further includes a process station which includes one or more separation reactors as well as other process reactors and sub-systems required by the method.

In the preferred embodiment of the invention, the free-floating macro-algae are cultivated by a combination of natural circulation of currents and by the surface dispersion of ammonium produced by the system. The ammonium is dispersed by the same vessels used to harvest the algae as shown schematically in Figure X. In the preferred embodiment, the algae are harvested on to the vessels by means of an inclined ramp inserted obliquely into the surface growing area. The inclined ramp is equipped with automated cutting blades to prevent entanglement. The harvested material is delivered mechanically up the ramp and into the vessel's algae hold where it is subjected to mechanical compression to both dewater the algae and create additional storage space. The harvest and fertilization vessel described is not intended to be limiting in any form or manner, and it should be evident to a person skilled in the art that the harvesting and fertilization may be implemented in other ways. In land-based systems, for example, the harvest transport vessels may comprise trucks or trains, or other land-based transport means.

Following the harvesting and dewatering, the algae are transported by the same vessels to the processing platform where they may be mixed as necessary with other feedstock materials to arrive at an optimal mass ratio which, for exemplary purposes, may comprise 40% carbon, 35% inorganic elements, and 25% water. The ratio of the various feedstock materials may be adjusted by a person skilled in the art, according to the properties of the algae, by altering the amounts of other inputs such as process captured CO₂, seawater, natural sand, or other carbon-containing materials imported to the systems.

Separation Step: The next stage of the process comprises the thermal separation or depolymerization of the feedstock. In the preferred embodiment, thermal depolymerization is effected without combustion at high heat temperatures (>900° C.) by plasma arch technology. In other embodiments, the thermal separation is effected with combustion at medium heat temperatures (300° C. and 900° C.) by pyrolysis technology, or by low heat temperatures (<300° C.) by gasification technology. In the preferred embodiment the heat energy is provided by a portion of the biomass as fuel. In other embodiments, the heat energy is provided by concentrated solar power or by wind energy. In yet other embodiments, the thermal separation may be effected by a combination of heat temperatures and technologies. The thermal separation technologies may be selected and adjusted for temperature, pressure, catalysts, and thermal media by persons skilled in the art of biomass depolymerization, combustion and catalysis. In the preferred embodiment, thermal depolymerization creates a product gas and a vitreous slag of variable composition.

In the preferred embodiment, this product gas is separated into several derivative gas streams. Some of the product gas is diverted to a water-gas-shift reactor for the production of H₂ to be used in the ammonia production stage as described further on below. N₂ and CO₂ are separated from the product gas using, in the preferred embodiment, permeable membrane technologies and are then diverted for use in the ammonia and bicarbonate stages described below. The remaining product gas is cleaned and polished to create a Syngas for process energy uses either as electricity generated by combined cycle turbines, or as bunker oil for the various transportation needs of the system, produced using Fischer-Tropsch, or other energy technologies. Heat exchange technologies are used throughout to capture and re-use waste heat.

In accordance with an embodiment of the invention, the system is adapted to supply substantial portions of its own energy needs. Additional energy inputs such as wind or solar generation, or biodiesel from outside the system, may be used to compensate for insufficient amounts of net energy derived from the algae.

Transformation Step: Ammonia Production: In accordance with an embodiment of the invention, ammonia may be produced using the Haber process. The process involves passing reactants several times over a catalyst until a yield of approximately 98% is achieved. The basic formula for this step is:

N₂(g)+3H₂(g)→2NH₃(g), ΔHo=−92.4 kJ/mol

Useful byproducts may be recovered from the Haber process. As mentioned earlier, the ammonia synthesis reactants are looped over the catalyst several times, and both argon and methane tend to accumulate in the loop, requiring removal. In some embodiments of the invention, the recovered argon may serve as an inert medium in the separation reactor. Optionally, the recovered methane may be blended into the separation step product gas for transformation into useful energy.

Transformation Step: Brine Production: In accordance with the preferred embodiment of the invention, a constant stream of brine (concentrated sea water) is needed for sodium-bicarbonate production. For purposes of this exemplary description, conventional reverse osmosis membrane desalination may be used, although other desalination methods and sub-systems may be used in other embodiments. For example, thermal desalination methods with or without fresh water recovery may be used. The final briny water solution is supplied to the sodium-bicarbonate sub-step. In some embodiments of the invention, the remaining fresh water is available for human use, for example, both within and outside the system. Optionally, the remaining sea water is available for production (extraction) of Lithium, Uranium, and other rare elements.

In some embodiments of the invention, the desalination sub-step may require an additive to prevent corrosion of components. For example, the additive may include Chlorine as an anti-fouling agent, and which may be obtained from the sodium-bicarbonate step where ammonium chloride is a byproduct. Optionally, the desalination components may be partially, or wholly, constructed from an anti-corrosive materials.

Following recovery from the desalination system, the ammonium chloride may be added back to the dispersion stock. In some embodiments of the invention, chlorine may also be added to the freshwater product to prevent fouling.

Transformation Step: Sodium-Bicarbonate and Ammonium Chloride Production: In accordance with the preferred embodiment of the invention, a modified version of the Solvay process is adapted to produce sodium-bicarbonate for sequestration. This end product is reached in one step:

NaCl+NH₃+H₂O+CO₂→NaHCO₃+NH₄Cl

The ammonium chloride and the sodium bicarbonate are thermo-chemically separated and diverted to their ultimate dispersion systems described in subsequent steps.

In an alternate embodiment of the invention, a sodium-carbonate-slag material is produced for sequestration purposes. In this alternative embodiment, the ammonium chloride is separated out thermo-chemically while the sodium bicarbonate is heated according to this reaction:

2NaHCO₃+HEAT→Na₂CO₃+H₂O+CO₂

The product water resulting from the process may be either added to the desalination fresh water product or discharged. The CO₂ may be partially recycled back into the first step of the sodium-bicarbonate reaction with the remainder optionally sent back to the separation reactor or released to the atmosphere. Furthermore, in this alternate embodiment, silica has been combined with the other feedstocks into the separation step to produce a vitreous slag. The vitreous slag is partially cooled to a temperature high enough so that the slag retains enough elasticity to allow mechanical mixing with the sodium carbonate (Na₂CO₃) yet sufficiently low to prevent the sodium carbonate from disassociating. The resulting sodium-carbonate-slag material is then deposited to the sea bottom or other geological formation for sequestration. In one such embodiment, Silica (sand) is taken from a surface or sea bottom terrain and the manufactured sodium-carbonate-slag gravel is put in its place. For example, this procedure may comprise a shallow water dredge mining operation. Optionally, the procedure may comprise a deep water dredge mining operation. Optionally, the procedure may comprise a land-based operation. In another embodiment, the sodium-carbonate-slag material is cooled to 1-2 inch pea-gravel size and dispersed directly into the sea either from the processing platform or from a dispersion vessel, whereupon the material will sink to the bottom for permanent sequestration. In another embodiment, the sodium-carbonate-slag material is cooled into pea-gravel, building bricks, or other useful forms as a building material and shipped to a commercial port.

Sequestration and Dispersion Steps: According to the preferred embodiment, the sodium bicarbonate product is mechanically injected from the processing platform into the unmixed layer of the ocean (below 200 m) through retractable tubing. The bicarbonate is expected to remain sequestered in the unmixed zone for at least 6,000 years. Alternatively, the sodium bicarbonate is taken by ship to another area where it may be injected from the ship into the unmixed layer of the ocean (below 200 m) through retractable tubing.

In the preferred embodiment, the ammonium chloride is dispersed by the harvesting vessel to fertilize the algae crop. Furthermore, any ammonium chloride not taken up by the algae will be carried by currents to other areas of the ocean where it will continue to fertilize phytoplankton and thereby increase the biomass of these areas, including possibly the biomass of higher trophic level organisms such as fish, marine mammals, and sea birds.

Other Uses and Products: In some embodiments of the invention, the method may be adapted to have other productive and industrial purposes that are not related to carbon capture and sequestration. This flexibility may help to justify capital expenditures required for such a project by providing a useful life beyond carbon capture and sequestration. In an exemplary embodiment, the mobility of the processing platform means that they may be moved to other areas for other uses, similar to floating oil drill rigs today. In one exemplary embodiment, the system may be moved to an area of excessive nutrient loading to collect and process macro-algal blooms, thereby remediating a condition of hazardous eutrophication. In another exemplary embodiment, the system may be moved to an area of marine debris to collect and process the floating trash. In another exemplary embodiment, the system may be used to process carbon that has been captured from existing power generation or industrial facilities (end of pipe capture) and been transported to the system. In other embodiments, possible non-carbon capture and sequestration uses of the system may include, for example, solid waste disposal (including sewage solids), landfill reclamation, hazardous waste disposal, water desalination, renewable energy creation (any combination of electricity, heat, liquid fuels, and/or Hydrogen), fertilizer and feeds production, metals production, lithium production, sea-water uranium extraction, building and road construction materials, or other combinations thereof. Due to this flexibility of uses, the system need not be decommissioned when, and if, the carbon capture and sequestration purpose becomes moot.

The system and method have been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art.

The preferred embodiment of the system describes a single processing platform. It may be evident to a person skilled in the art that the system may be expanded to include numerous processing platforms so as to capture and sequester additional amounts of carbon. In an alternate embodiment, enough platforms could be deployed to sequester, for example, 80% of the annual CO₂ emissions of the United States, or 80% of world's annual CO₂ emissions, or 1 billion tonnes of carbon equivalents or any other amount or to be used for other useful purposes without any consideration of carbon emission levels or atmospheric concentrations.

All patent applications, published patent applications, issued and granted patents, texts and literature references cited or alluded to in this application are hereby incorporated by reference in their entirety to more fully describe the state of the art to which the present invention pertains and is an improvement upon.

I claim:

1. A method of carbon capture and sequestration comprising:
(a) capturing of carbon from the natural or man-made environment so that it becomes bound within a carbon containing material;
(b) separating the carbon from the material in step (a) using a thermo-chemical process;
(c) transforming the separated carbon from step (b) into a sodium+carbon, chemically bound substance using a thermo-chemical process;
(d) sequestering the sodium+carbon substance from step (c) by dispersion or deposition into the natural environment; and
(e) using the non-sequestration materials produced in the course of steps (a-d) to make beneficial co-products and by-products.

2. The method according to claim 1 wherein the capturing of carbon is effected by photosynthetic plants or organisms.

3. The method according to claim 1 wherein the capturing of carbon is effected by synthetic chemical process.

4. The method according to claim 1 wherein the capturing of carbon is effected by the collection and introduction into the process of any carbon containing waste product, such as municipal residue biomass, agricultural wastes, sewage sludge, timber milling wastes, refuse derived fuel, paper making wastes, and construction wastes.

5. The method according to claim 1 wherein the capturing of carbon is effected by the cultivation of free-floating algae.

6. The method according to claim 1 wherein the capturing of carbon is effected by the cultivation of free-floating algae in a floating enclosure.

7. The method according to claim 1 wherein the capturing of carbon is effected by the cultivation of free-floating algae in a floating enclosure consisting of moored floating cylinders with weighted netting stretching between the cylinders in the water.

8. The method according to claim 1 wherein the capturing of carbon is effected by the cultivation of free-floating algae in a floating enclosure consisting of moored floating cylinders topped by wind turbines with weighted netting stretching between the cylinders in the water.

9. The method according to claim 1 wherein the capturing of carbon is effected by the cultivation of free-floating algae harvested by a vessel that scoops up the algae by means of an inclined plane skimming the surface waters.

10. The method according to claim 1 wherein the capturing of carbon is effected by the cultivation of free-floating algae harvested by a vessel that scoops up the algae by means of an inclined plane skimming the surface waters and that carries the algae into a compression chamber on board where the algae is dewatered.

11. The method according to claim 1 wherein the capturing of carbon is effected by the cultivation of free-floating algae harvested by a vessel that simultaneously releases fertilizing nutrients into the water

12. The method according to claim 1 wherein the separation of carbon is effected by gasification at a temperature between 300° C. and 900° C. of a carbon containing material.

13. The method according to claim 1 wherein the separation of carbon is effected by pyrolysis at a temperature greater than 900° C. of a carbon containing material.

14. The method according to claim 1 wherein the separation of carbon is effected by a membrane mediated gas separation process.

15. The method according to claim 1 wherein the separation of carbon is effected by a thermo-chemical separation process.

16. The method according to claim 1 wherein the separation of carbon is effected by thermal reactions taking place within an inert gas medium.

17. The method according to claim 1 wherein the separation of carbon is effected by thermal reactions taking place within an air medium.

18. The method according to claim 1 wherein the separation of carbon is effected by thermal reactions taking place within a steam medium.

19. The method according to claim 1 wherein the separation of carbon is effected by thermal reactions taking place within a carbon dioxide medium.

20. The method according to claim 1 wherein the separation of carbon is effected by thermal reactions taking place within any sequential combination of inert gas, air, water steam, and carbon dioxide media.

21. The method according to claim 1 wherein following the separation of carbon the product gas therefrom is subjected to a water-gas-shift reaction.

22. The method according to claim 1 wherein following the separation of carbon the product gas therefrom is used to create energy for process uses.

23. The method according to claim 1 wherein following the separation of carbon the product gas therefrom is used to create a syngas that is then used to power a gas turbine.

24. The method according to claim 1 wherein following the separation of carbon the product gas therefrom is used to create a syngas that is then used to manufacture liquid fuels.

25. The method according to claim 1 wherein following the separation of carbon the product gas therefrom is used to create a syngas that is then used to fuel a power generator.

26. The method according to claim 1 wherein the transformation of carbon is effected by a process comprising the following steps:
(a) the accumulation from product gas of: N₂, CO₂, and H₂;
(b) an ammonia creation process such that: N₂(g)+3H₂(g)→2NH₃(g);
(c) a desalination process producing: NaCl and H₂O;
(d) a sodium bicarbonate creation process such that:
NaCl+NH₃+H₂O+CO₂→NaHCO₃+NH₄Cl; and
(e) the separation of NaHCO₃ from NH₄Cl

27. The method according to claim 1 wherein the transformation of carbon is effected by a process comprising the following steps:
(a) the introduction of natural sand into the separation reaction step to form a vitreous slag residue in addition to a product gas;
(b) the separation from the product gas of: N₂, CO₂, and H₂;
(c) an ammonia creation process such that: N₂(g)+3H₂(g)→2NH₃(g);
(d) a desalination process producing: NaCl and H₂O;
(e) a sodium carbonate creation process such that:
NaCl+NH₃+H₂O+CO₂→NaHCO₃+NH₄Cl, and
2NaHCO₃+HEAT→Na₂CO₃+H₂O+CO₂; and
(f) the thermal mixing of Na₂CO₃ with the vitreous slag residue to form a sodium carbonate-slag sequestration matrix

28. The method according to claim 1 wherein the sequestration of carbon is effected by the dispersion of bicarbonate to the unmixed layers of the ocean.

29. The method according to claim 1 wherein the sequestration of carbon is effected by the deposition of bicarbonate to geological formations.

30. The method according to claim 1 wherein the sequestration of carbon is effected by the dispersion of ammonium to the mixed layers of the ocean.

31. The method according to claim 1 wherein the sequestration of carbon is effected by the deposition of the sodium carbonate-slag sequestration matrix to geological formations.

32. The method according to claim 5 wherein product ammonium is applied as a fertilizer to stimulate the growth of free-floating algae.

33. The method according to claim 1 wherein product fresh water is distributed to human populations for human use.

34. The method according to claim 1 wherein product slag residues are used to create building materials.

35. The method according to claim 1 wherein product ammonium is distributed to human populations for human use.

36. The method according to claim 1 wherein product chloride is distributed to human populations for human use.
